(19) United States
(12) Patent Application Publication
(10) Pub. No.: US 2026/0041037 A1
(43) Pub. Date: Feb. 12, 2026

(54) SET OF SNAPPING ROLLERS, CORN HARVESTER HEAD INCLUDING THE LATTER, AND A METHOD FOR CUTTING EAR CORNS FROM THE PLANT

(71) Applicant: CARLOS MAINERO Y CIA. S.A.I.C.F.I., Bell Ville (AR)

(72) Inventor: Carlos Oscar MAINERO, Bell Ville (AR)

(21) Appl. No.: 18/796,605

(22) Filed: Aug. 7, 2024

(51) Int. Cl. A01D 45/02

(52) U.S. Cl. CPC A01D 45/025

(57) ABSTRACT

Disclosed is a pair of corn snapping rollers. Each roller has a squared shaft to which intermeshed flutes or blades are bolted. The flutes or blades possess a series of triangular teeth ending in tips that firmly sink into the stalks to lower them and open cracks therein, regardless of their moisture or condition, with the teeth of a roller interspersed with those of their counterpart. Both rollers have the same diameter and tangential velocity. By rotating the rollers, the blades approach each other at a remarkably close distance of a few millimeters. The blades of the same roller may be equidistant from each other or may be paired, such that the distances between consecutive blades are unequal.

### CROSS-REFERENCE TO RELATED APPLICATIONS

Not applicable.

### BACKGROUND OF THE INVENTION

The present invention has applications in corn harvester machines and concerns, particularly, the snapping rollers used in corn harvester heads.

During the mechanized harvest of corn, which has been carried out for decades, the harvester mounts on its front part a specific head for the said task and whose function is to separate the ears of corn from the rest of the plant and introduce them continuously and orderly into the harvester. For this purpose, it has a series of snouts 11 that are located between rows of the crop and guide the plants toward the snapping rollers 12. Said rollers 12, which have longitudinal protrusions 13 in the form of flutes or blades as indicated in FIGS. 1 and 2, take the plant and, as they rotate concentrically downward, pull in the stalk. On them, there are the deck plates that cover the rollers 14, which are responsible for separating the ear of corn as the plant continues its downward travel, and, over these, the gathering chains 15 which, placed on opposite sides of the passageway for the stalks 17, move backward and have attachments extending into the interior of passageway 17, whose function is to snag the stalks to move them backwards into passageway 17. Once separated, the ears are also carried by the gathering chains 15 through a channel 18 formed between the hoods towards the collecting crossauger, which concentrates the material and delivers it to the combine's conveyor. See U.S. Pat. Nos. 2,882,669, 2,762,494 and 2,960,813.

The primary objective of the head is to ensure that only the ear of the crop with the least amount of material other than grain enters the combine—MOG: “Material Other than Grain”—in order to prevent the combine from wasting energy in processing material with no commercial value and reducing costs and losses of harvest due to the interference that said material produces in the threshing, separation and, cleaning processes carried out therein. With respect to the amount of MOG allowed to consider a head's performance as acceptable, the ANSI/ASAE Standard S343.4 JUN2015 indicates that for a corn harvest to be considered acceptable, the non-grain (MOG)/grain ratio should be in the range of 0.4 to 0.8. In other words, 0.4 to 0.8 kg MOG per kilo of corn grain entering the combine. This ratio varies depending on the conditions of the crop and, fundamentally, on the design of the head so as to adapt to these conditions, but any reduction in the said ratio will have economic benefits both by the increase in working capacity, reduction in costs, and reduction of harvest losses.

During operation, (referring to FIGS. 1 and 2) snouts 11 are located between the corn rows and are the first elements that come into contact with the crop, and whose function is to straighten and orient or reroute the plants to the row-unit 19, one per crop row to be harvested by the head, consisting, basically, of a structure or frame that supports the deck plates 14, gathering chains 15, the snapping rollers 12, and the transmission gearbox thereof. The snouts 11 collaborate mainly in crops with downed and/or crossed plants and in misaligned crops (with uneven spacing between rows). For this purpose, they must be able to “penetrate” below the downed plants and, as the machine continues to advance, deliver them individually (without detaching them up) to the gathering chains 15, since it is more convenient for the plants to reach the latter as erect as possible. In the case of row independent heads, they must also be able to absorb the misalignments of the stalks entering through the entire width of the channel formed between both snouts of each row-unit without breaking the stalks, turning the plants and, even, without causing the shedding of the ears on account of violent shakes (see Argentine Patent No. 81.582).

The gathering chains 15, whose useful working path runs opposite to the direction of travel advance, have a series of attachments or lugs that play two fundamental jobs, one of which is to transport the ears toward the head's collecting crossauger once they are separated from the rest of the plant. Its other function is that of collaborating with snouts 11 in transporting the plants towards the center of the row-unit traction zone formed by a set of snapping rollers 12. Said task is of fundamental importance with downed crops, with uneven spacing between rows, or when the stalks enter from outside the center of the row-unit 19 and ends once the plant is taken by these, which are responsible for pulling the plant downwards as they continue to move it backward. See patent AR 74.937.

The deck plates covering the rollers 14, two per row-unit, are located between the snapping rollers 12 and the gathering chains 15. Their function is to separate the ears from their stalks as they are pulled by the snapping rollers 12. The opening between plates 14 should be variable so as to be able to accommodate different harvesting conditions within the same field or between fields.

For each crop, a sufficiently wide spacing must be provided to allow the stalks to pass freely between them when they are pulled by the snapping rollers 12, but at the same time sufficiently closed to prevent the ears from passing through and coming into contact with the rollers 12, causing shattering losses. The snapping rollers 12, two per row-unit, which rotate concentrically, are responsible for pulling the plant downwards to prevent it, or parts thereof, from entering together with the corn ear into the combine.

In general, the rollers 12 have two portions. The front-end portion 21 has spiral 22 responsible for helping the ordered ingress of the plants into the actual traction zone. The throughput of spiral 22 is given by the length of its pitch (distance traveled by the plants on a full turn of the roller) and its rotational speed. Such a throughput must keep some relationship with the speed of travel to produce a continuous feed. The height of the flight is important to maintain an effective throughput in the case of wet crops, without producing clumps of plants at the entry of the traction zone.

The front end 21 subsequently overlaps a traction zone (as is usually known) 23 whose function is to lower the plant carried by the front end 21; this task must be performed with great gentleness to prevent loss of corn ears due to the shaking and reduce the risk of cutting the plants. Its design must allow keeping its traction capacity constant with low power consumption over all portions of the plant, without cutting it, taking into account that the diameter, structure, and resistance of the stalk at its bottom is much greater than at its highest part. It is desirable to maintain these qualities both under normal conditions, as well as in the most extreme conditions of crop fragility, e.g., high moisture corn, which has turgid, green and strong stalks; dry and downed corn, with thin and fragile stalks, etc.

In the same manner that the throughput of the spirals of the front end of the rollers 12 must keep some relationship with the speed of travel (equal but opposite to neutralize the effect of head advancement in the crop), for the rollers 12—regardless of the type of longitudinal protrusions 13 (flutes or blades) that they have—to be able to transport the stalks backwards with identical relation to the speed of travel as the plants are lowered, the row-units 19 work at an angle to the ground, so that when rotating each new contact of the vertical stalk relative to the inclined rollers 12 will be in a more backward position than the latter, achieving both effects simultaneously: lowering the plant as it is moved backward. For any given roller design 12, the throughput will be primarily conditioned by both the angle of the row-units and well as its peripheral speed.

In some agroclimatic conditions, it is desirable that, as the plant is lowered, the rollers 12 also cause damage to the stalks by both opening longitudinal cracks and cutting them into pieces so as to allow greater contact surface or ingress to microorganisms present in the soil responsible for its degradation once the processed plant makes contacts with it. Under other conditions, on the contrary, it is desirable that the stalks, damaged longitudinally or not, remain adhered to the plant and without cutting to avoid being blown by the wind. And so on for many other agroclimatic or harvesting conditions that present needs that, in some cases, are even antagonistic.

For this reason, in the prior art can be found rollers 12 with intermeshing flutes, opposed flutes, intermeshing blades, and opposed blades; with a greater number of flutes or blades 13, with straight or helical flutes or blades, toothed or smooth, with equal peripheral diameters and speed, with different peripheral diameters and speeds, etc., trying to prioritize some of these needs depending on the prevailing condition in the country or region where they are marketed. See U.S. Pat. Nos. 1,951,026, 5,282,352, 7,237,373, 7,373,767, 8,464,505, 8,720,172, 8,955,297, 9,210,842, 9,560,804, 9,668,414, 10,039,232, 10,172,286, 10,314,233, AR 109,338, AR 111,053, U.S. Pat. Nos. 10,874,052, 11,219,164, etc.

Beyond the many existing design variants, for the purposes of this patent, we can classify the stalk roller assemblies into two large groups: those having intermeshing flutes or blades and those having opposed flutes or blades. FIG. 3 shows a pair of rollers 12 with intermeshing blades 13′ which, however, have several advantages compared to the others, press the plant alternately between a blade 13′ and the center of the opposing roller 12, so that, upon lowering, the plant is shaken violently toward both sides causing, under certain crop conditions, the premature separation of the corn ear E which may sometimes fall out of the head causing its irreversible loss. At the same time, FIG. 4 shows a pair of rollers 12 with opposing blades 13″, with enough clearance between their edges to “squeeze” the stalk between both rollers. The advantage of the opposing blades is that they press the stalk T always on the tangent of their contact diameter and, therefore, lower the plant in a straight line and without lateral movements that would cause violent shaking of the plant.

From the point of view of the function of lowering the plant without shaking, which can produce losses of corn ears E by detachment before reaching the deck plates, this effect does not vary much if blades are used instead of flutes or vice versa as protrusions in the traction zone of the rollers.

FIG. 5 shows one of the two identical rollers exhibited in U.S. Pat. No. 7,237,373 (Kemper), cited above. The roller body 16 has a main part or cylindrical traction zone 60 from which radially projecting blades 62, the middle region of which is toothed in order to improve the gripping of the plants 64. The teeth have flat rectangular outer edges or faces that have a larger surface for gripping the stalks without penetrating them. Both rollers are mounted with opposed flutes as indicated in FIG. 4 and rotated at the same speed.

FIGS. 6A and 6B show a pair of rollers 110; 120 of a row-unit assembly 100 of a corn head known by the national patents AR 109,338 and AR 111,053 (Kingdom AG Concepts) cited above and appearing as the closest reference. Both rollers rotate at the same speed but have unequal diameters causing a tangential velocity differential at the outer peripheries of their main bodies 112; 122 including opposed flutes 140, toothed at their outer edges (but not serrated as indicated below) to pierce or clamp the plant stalks and pull them down into the deck plates 40; 42 to separate the ears E from the stalks T. While flutes 140 clamp and pierce the stalks, the differential speeds of the rollers open, tear and crush the stalks as they pass between the peripheries of the pair of adjacent rollers. The outer edges of the flutes 140 can include a plurality of straight or curved teeth 174 that, compared to the straight edges, would be more effective and more aggressive at tearing the stalks if deeper and more separated as well as by increasing the speed of the rollers. The pair of rollers'teeth in flutes 140 are longitudinally intermeshing and the edges of the teeth of the flutes of the major roller 120 are curved downwardly and therefore they rotate faster than those of the slower flutes of the minor roller 110 producing internal shear forces on the stalk.

This combination of differential speed and clamping forces in opposite directions of the flutes 140 of both rollers 110; 120 seeks a more aggressive action to break apart the stalks of corn plants and open or fracture the rod of the stalk along it, resulting in more efficient stalk decomposition. This task is facilitated by the incorporation of transverse discoidal blades 150 at periodic intervals in the roller to cut the stalks into sufficiently short fragments which, having been previously shredded partially by the flutes, allow them to decompose and disintegrate rapidly, thus avoiding the need for stem shredders.

Certain fragility conditions, caused by excessive or extremely low turgor of the stalks, can also cause cutting thereof in their most fragile zone that are the knots, thereby loading more material into the head and hence into the harvester (increase in MOG). This problem occurs, in effect, in all known designs and is basically the problem the present invention seeks to solve.

When, in addition to the corn ear E, by the action of the rollers 12, parts of the stalk T and leaves are cut and are left on the row-unit 19, a stack or heap of a “corn husk” or light material can be formed in the center of the head, within the transition zone between the collecting crossauger and the combine's conveyor. Under certain conditions, the head's crossauger cannot deal with the excess of material and the speed of travel is limited severely; in others, such surplus generates serious complications to the combine, causing crop losses that can also only be reduced by limiting the speed of travel.

There are so many crop conditions and agro-climatic needs to be faced, and such a vast typology and variety of roll designs for each one, only proves that so far there is no single type of roll that can adapt to all of them while maintaining unchanged its fundamental principle, which is to pull the plant downwards and detach the ear, while avoiding the entry of other portions of the same (i.e., MOG) into the combine and preventing the loss of ears in the process. Basically, trying to meet other needs, besides pulling the plant T downwards without leaving nothing but the corn ear E on the head makes it, in many cases, necessary to resign oneself, at least in part, to not being able to meet its main objective, even being admitted in ANSI/ASAE S343.4 JUN2015 ratios of MOG well above the ideal minimum, which is approximately 0.15 and corresponds to the weight of the components of the corn ear other than the grain with respect to the latter, that is, what is known in the rural medium such as the “husk” or inseparable components of the corn ear that are not grain.

Patents AR 109,338 and AR 111,053, referred to above, teach that meshing the teeth of a roller assembly so as to minimize the clearance between their flutes, the stalks are prevented from “slipping” over the flutes over a wide range of crop conditions; once the stalk has been caught, it may be cut without slipping. Notwithstanding the advantage of separating these meshing flutes for unfavorable crop conditions, rollers 110; 120 suffer a high rate of wear due essentially to the differential tangential velocity of the meshing flutes.

### SUMMARY OF THE INVENTION

The difference between 0.15 and 0.4 to 0.8 is the amount of MOG formed by parts of the plant other than the corn ear accepted by Standard ANSI/ASAE S343.4 and whose reduction is a primary objective sought by the novel snapping rollers of the present invention.

The object of the present invention is to provide a set of snapping rollers for a row-unit of the type of opposing flutes or blades that, under any crop condition, from turgent and humid to extremely fragile and dry, can completely lower the plant without leaving behind on the deck plates nothing else but the corn ear, independently of the treatment to the rest of the plant from the standpoint of the remaining crop residue in the field, commonly referred to as “stubble”. With respect to the latter, a secondary objective is to achieve an intermediate treatment that allows a good adaptation to most agroclimatic conditions.

It involves a system of snapping rollers comprising longitudinal protrusions, either flutes or blades, which work with the known principle of opposing blades, that is, the protrusions work opposite of one another, which, as described above, avoids the typical violent shakes of the system of intermeshing protrusions since, being mutually supported, the plant is lowered without shaking, reducing the risk of loss of corn ears with fragile insertion. Such protrusions (flutes or blades) have the novel feature that they are toothed or serrated, with teeth extending along at least a substantial length of the protrusions, i.e., by the flutes if they are flutes or by the edges if they are blades.

Optimally, the teeth of a roller mesh with those of their counterpart. The blades rotate at the same tangential speed and, when approaching each other and aligning with the diameter of the stalk, they make contact with the latter, supporting each other. By continuing its downward displacement, and hence getting nearer to each other, the tip of each tooth is driven into the plant, which opens longitudinal cracks in its fibers and compresses them to overcome the inertia of the still plant, thus generating the first downward pulling motion. Once in descending motion and before the pair of blades that are in contact with the stalk lose their traction thereon, the next pair of blades makes contact, and all they have to do is to keep the stalk moving downwards, and so on until the entire plant is lowered even though the diameter of the stalk is significantly reduced to a higher height of the plant.

The interference of the longitudinally alternating teeth as well as pairing blades of a same roller, in other words get them close together mutually to pairs, improves the proposed objective since they firmly take the stalk, produce longitudinal cracks in their fibers and from them pull it downward without releasing it even though it has been cut and detached from the rest of the plant in the transverse direction.

The larger initial diameter favors a firmer traction on the stalk base (the diameter of which is typically about (30 to 35 mm) allowing the plant inertia to overcome more easily while the thinner and generally more fragile stalk of the upper portion of the plant (the diameter of which is typically about 5 mm) will require less traction effort and lower aggressiveness of the teeth in said portion thereof.

Among other advantages found in the present invention, apart from the main one related to the best crop yield under unfavorable crop conditions and the use of opposing flutes or blades, it is the simplicity of construction and manufacturing cost-effectiveness resulting from the possibility of manufacturing each roller with flutes or blades bolted to the roller shaft.

Unlike what is known from the prior art with flutes or blades mesh with their matching counterpart, optimally the rollers both have the same diameter and, therefore, identical peripheral or tangential speed, reducing the wear thereof. Optimally, the teeth of the blades are triangular, ending in tips that pierce firmly the longitudinal fibers of the stalks regardless of crop condition (turgid or fragile, dry, or wet, etc.).

### BRIEF DESCRIPTION OF DRAWINGS

Both the main object of the invention and the advantages achieved will be appreciated in the following description of a preferred embodiment, with references to the accompanying Figures, in which:

FIG. 1 is a schematic side elevation view of a row-unit of a known corn harvester head.

FIG. 2 is a schematic plan view of a pair of snapping rollers of a row-unit known as that of FIG. 1.

FIG. 3 is a schematic cross-section through a known row-unit showing how a pair of equal intermeshing bladed rollers picks and pulls the stalk of a corn plant downward to remove the corn ears.

FIG. 4 is a schematic cross-section through a known row-unit showing how a pair of the non-equal opposing snapping rollers picks and pulls the stalk of a corn plant downward to remove the corn ears.

FIG. 5 is a perspective view of a roller known by U.S. Pat. No. 7,237,373 for a corn header.

FIGS. 6A and 6B are perspective and cutaway views, respectively, of the pair of rollers of a row-unit assembly of a corn head known by patents AR 109,338 and 111,053.

FIG. 7 is a perspective view of a pair of snapping rollers of toothed serrated blades according to a preferred embodiment of the snapping assembly of the present invention.

FIGS. 8A and 8B are plan views of the snapping rollers assembly of FIG. 7 in two different rotational positions; FIGS. 8C and 8D are transverse cuts corresponding to FIGS. 8A and 8B, respectively.

FIGS. 9A to 9D are schematic cross-sections of the snapping rollers assembly of FIG. 7 illustrating the paired blades, which is non-equidistant, of each roller and the working sequence, in accordance with an embodiment of the present invention.

FIG. 10 is a perspective view of one of the snapping rollers with serrated blades of FIG. 7.

FIG. 11 is a photographic image of the stubble resulting from an application of the present invention.

FIGS. 12A and 12B are perspective views of one and the other side showing the one-piece assembly with two paired blades for the roller of FIG. 10.

FIG. 13 is a cut of the median longitudinal plane of the roller shaft which illustrates its shape and its connection with the front-end spiral of the roller in FIG. 11.

FIG. 14 shows a perspective cross-section of the rollers set of FIG. 7 in two different rotational positions.

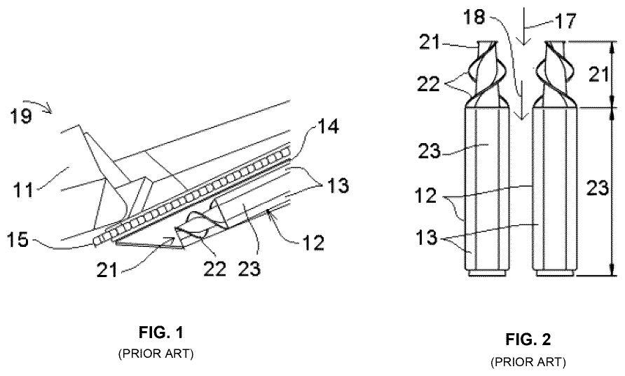

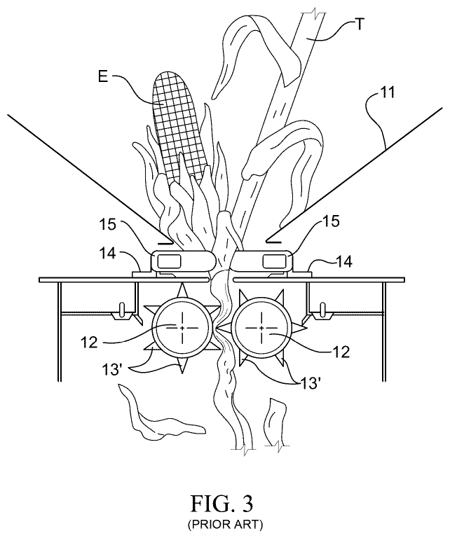

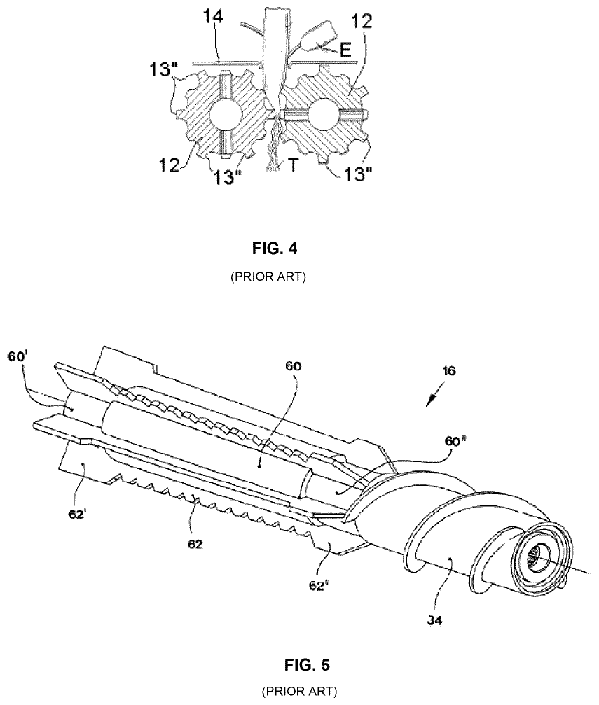

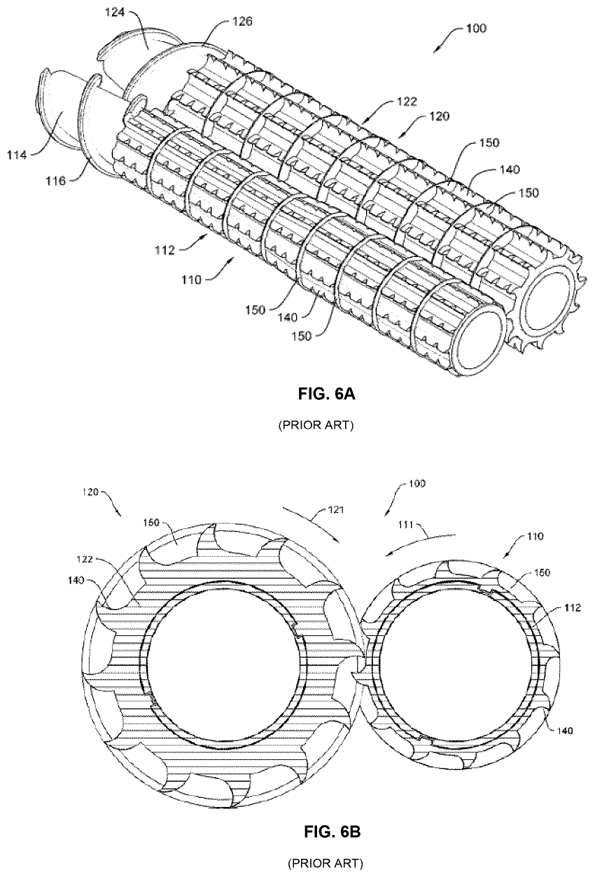

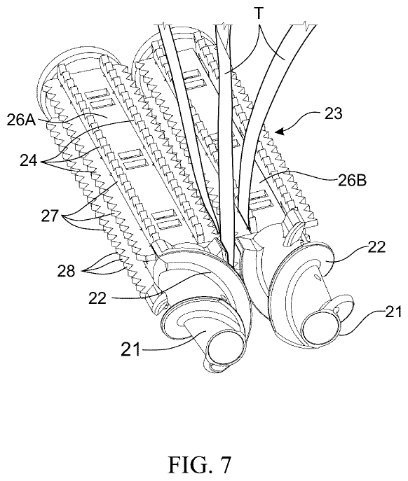

Finally, FIG. 15 is a plan view of a scraper plate that fits below the rollers assembly of FIG. 7.

In all Figures, equal references correspond to equal elements of the machine.

### DETAILED DESCRIPTION OF THE INVENTION

Starting with FIG. 7, a set of two snapping rollers 26A and 26B in operative relationship is illustrated, both of the same diameter (to rotate with identical peripheral or tangential speed), each with a tip 21 with a conventional spiral 22 in its front portion to encourage the ordered ingress of the plants to the traction zone itself 23 as explained previously. The helical flight of the spiral 22 continue rearward in straight protrusions shaped as blades 24 in this exemplary embodiment, which run longitudinally along traction zone 23 of rollers 26 (suffixes like “A” and “B” are omitted when generalized in the reference numerals), coinciding with said traction zone itself. Depending on the crop conditions and treatment to be given to the stubble, said straight protrusions may be blades with beveled edges forming sharp edges that produce a more aggressive treatment of the stubble or by longitudinal flutes 24 with blunt edges to achieve a less aggressive treatment on the stubble.

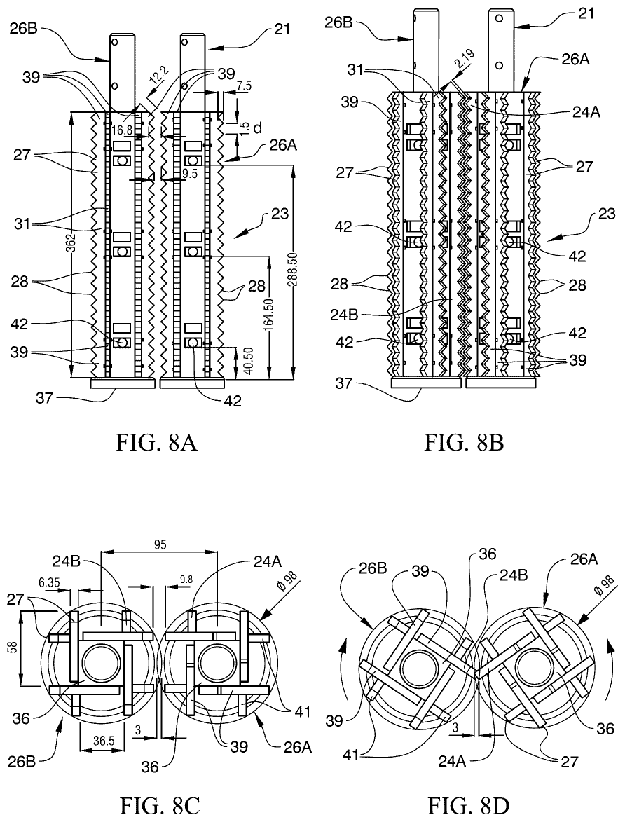

According to the present invention and unlike the blades of U.S. Pat. No. 7,237,373, AR 109,338 and AR 111,053 cited above, the blades 24 present serrated edges formed with isosceles triangular teeth 27, of straight edges, as shown in FIGS. 8A and 8B, running along the same plane as blade 24 and ending as tips 28 capable of penetrating the stalks T of corn plants.

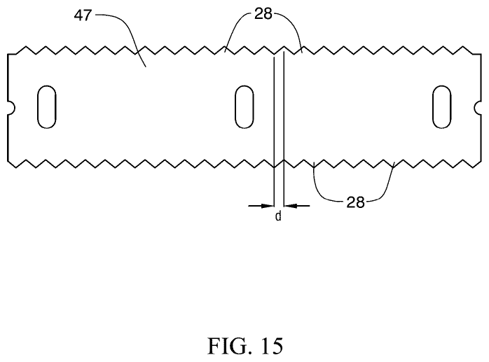

Snapping rollers 26 are mounted to the row-unit 19 (FIG. 14) of a corn head (conventional, not illustrated) so that blades 24 face each other at each rotation of the pair of rollers 26 to avoid typical violent shaking of the intermeshing flutes system, and since, as they support each other mutually, the plant is lowered without violent shaking, hence reducing the risk of corn ear losses in situations of fragile ear insertion.

In particular, the traction zone 23 of each roller in the exemplified embodiment is 362 mm in length and the diameter of the circumference circumscribing the tips 28 of their teeth is 100 mm. The distance between the axes of rotation of both is 95 mm. Each triangular tooth 27 measures 7.5 mm in height and the distance from one tooth to another is 15 mm measured between tips 28.

The flutes 24 or blades that make up the protrusions of the rollers 26 of the pair have a longitudinal offset relative to each other d of 7.5 mm equal to half the width of a tooth 27, such that the teeth 27 of a roller 26A mesh with those of their counterpart 26B. FIGS. 8C and 8D show the overlapping encounter of two meshed blades 24A and 24B after each turn when they face each other. It has been found empirically that when the closer the rollers are, the better, selecting an approximate clearance a as small as 1 mm and preferably not exceeding 3 mm between rollers at their maximum approach, measured parallel to an axial plane common to the pair of rollers, sufficient to “press”stalk T between both rollers 26.

The toothed blades 24 of any one roll 26 may or may not be equidistant from each other, provided that the pair of blades 24 (one from each roll 26A and 26B) that have the stalk T grasped do not lose contact before the next pair of blades 24 grasp and firmly pierce the stem. In this preferred configuration, blades 24 are not equidistant but are paired as shown in FIGS. 8C to 10, that is, are grouped from pairs 31 in roller 26, with a smaller distance between blades 24A and 24B of a same pair 31 than between successive pairs of paired blades (that is, the distance between the second blade, or follower blade, 24A of the pair 31A and the first or attack blade, 24A of the next pair 31B is less than the distance between fins 24A and 24B of the same pair 31A or of the same pair 31B, and so on), in order to reduce the power consumption and risk of cutting the plant at the entry point to the traction zone 23 of the rollers 26. That is, there are two contacts close to each other and a larger gap 32 up to the next pair of contacts but not so as to lose continuity in the downward movement: before a pair of blades 31 is released, the next one already has grasped plant T.

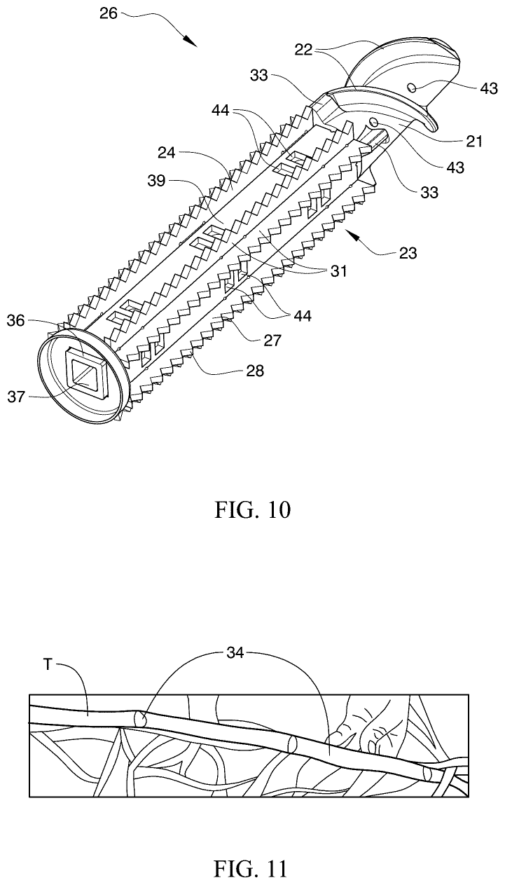

Both rollers 26A and 26B are the same construction-wise, with FIG. 10 representing any one 26 of these rollers 26A and 26B. In this construction embodiment, roller 26 comprises eight blades 24 grouped in four pairs 31 such that the two blades 24A and 24B of same pair 31 are perpendicular to each other while consecutive blades 24 but of pairs 31 different are parallel to each other, a configuration that amalgams construction cost-effectiveness and operational performance.

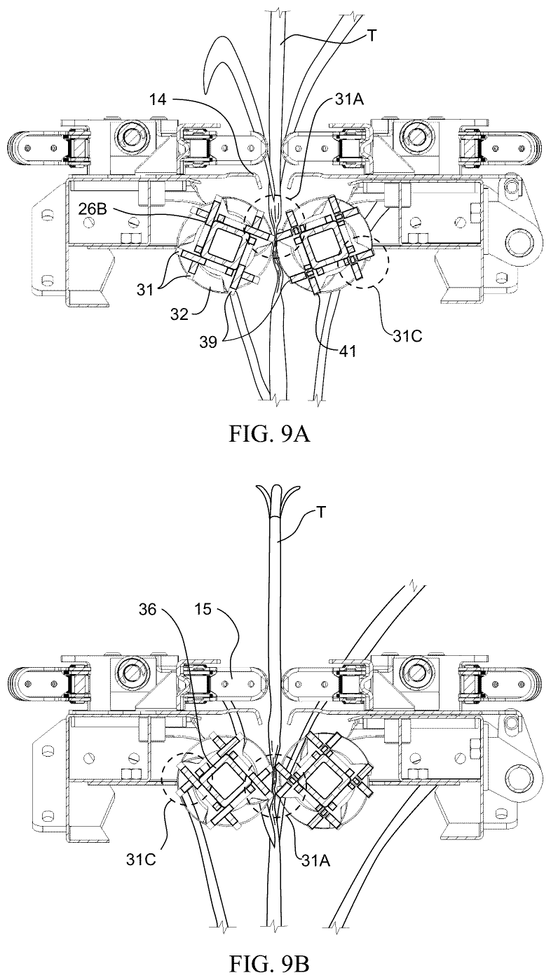

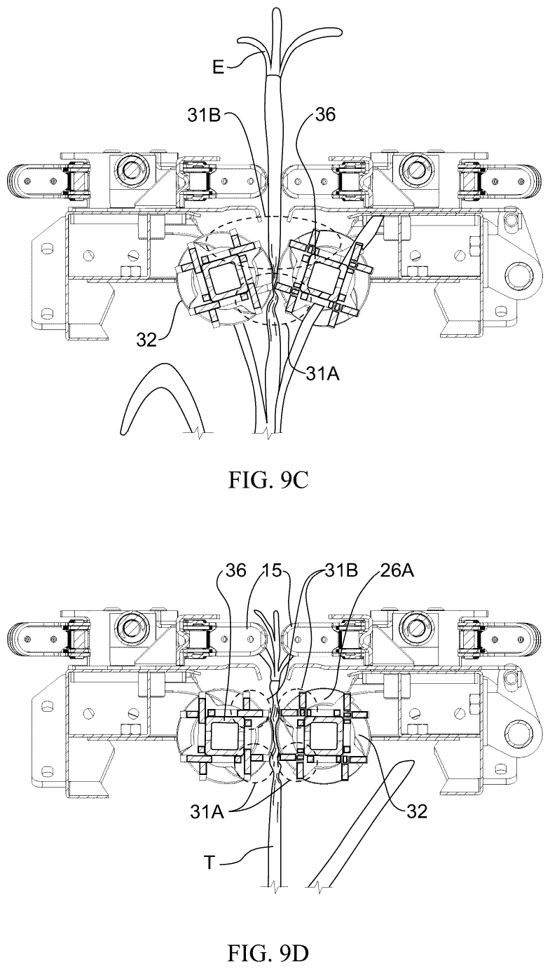

Spiral 22 of the tip 21 delivers the stalk T to a first toothed blade 24A aligned therewith so that the transition of stalk T to the first descending movement is fluid. On rotation, blades 24 of both rollers 26 approach each other and, by closing to the stalk T's diameter, they make contact with it as shown in FIG. 9A, thereby supporting each other. This first contact is designed to occur in the order of a 9.8 mm spacing between edges of the fins, although, it should be mentioned, this varies for each particular plant.

By continuing its downward displacement, and thus approaching, the edge 28 of a tooth 27 of each blade 24 pierces the stalk by opening longitudinal cracks in their fibers and compressing them to overcome the inertia of the still plant, generating the first movement. Such first contact with blades 24 (FIG. 9A) causes the beginning of the downward movement, that is, the one that must overcome the inertia of the still plant, which will occur at the portion of greater diameter, structure, and stalk strength, so the challenge is double and the risk of cutting the plant in that first contact is high. In order to overcome that initial inertia by eliminating the risk of cutting and loading the entire plant onto the head at that first contact, in the preferred configuration, the second pair of blades 31B is much closer to the first 31A than the third 31C so that it is those two pairs of blades 31 whose teeth 27 pierce the stalk T at said crucial moment. Once in downward movement and before the pair of blades 31A that is in contact with the stalk T lose their traction thereon, the next pair of blades 31B enter into contact (FIG. 9B) and whose only job is to keep the stalk T in downward movement and so on (FIGS. 9C and 9D) until the whole plant is lowered even though the stalk diameter T is significantly reduced at the higher height of the plant.

That is, two are ultimately the pairs 31 of blades 24A-24B which keep the stalk firmly grasped at that time so, in any case, if the stalk T is cut at the first and more aggressive contact, the second pair 31B of fins is firmly pinned much before it is released by the first 31A (it is still pinned to the stalk T the second blade 24 of the first pair 31A FIG. 9B), continuing the downward movement and completely eliminating the risk of loading onto the equipment the plant even though it may have been cut in the most aggressive initial contact.

While it will be furthest from the second, the third contact will take place before the second contact completely releases the stalk T (FIG. 9D) and the fourth will occur with the same time gap as the second was from the first, thus repeating the cycle until completing the full descent of the stalk T without losing traction thereon at any time, thereby ensuring the primary objective of a corn head that is to completely lower the plant leaving only the ear of corn on deck plates E.

On the other hand, the intimate contact between stalk T and teeth 27, as well as the preferred blade configuration 24 in a paired fashion 31, also ensure that the above description is replicated in all possible conditions of the crop as, as mentioned above, the principle takes advantage of the longitudinal strength of the stalks T which is maintained independently of its condition or turgidity. That is, the principle ensures that the blade pair 31's facing teeth 27 make contact before the pair of blades 31 currently in contact release the stalk, which allows them to be lowered even if they have been cut and furthermore, that such contact will be driven by piercing teeth 27 that open longitudinal cracks 34 in the stalk fibers T as FIG. 11 illustrates and presses it onto tooth 27 of its counterpart or opposite blade, ensuring a sufficiently firm contact to achieve effective traction under the most extreme possible crop conditions. It also allows lowering even down up to the thinner portion of stalk T since its preferred minimum distance a 1-3 mm between blades 24 of pair 26 ensures sufficient traction in the upper and thinner portion thereof, which will be pulled at a constant descent rate and will therefore require less effort to achieve only the continuity of the movement.

Many are the differences that can cause enormous performance contrasts between the most extreme crop conditions, such as high moisture and turgor and excessive brittleness because of dryness. But the attribute of the stalk that remains constant over such a wide range of conditions—and the basis on which this design relies—is the longitudinal strength of the fibers making up stalk T that is responsible for keeping it upright, since teeth 27 open the mentioned cracks 34 in the direction of the fibers and, when compressed together, achieve the necessary traction to bring them down with equal efficiency.

As for the secondary objective of achieving an intermediate treatment of the remnant plant waste in the field, commonly referred to as “stubble”, in order to allow a good fit with most agroclimatic conditions, said longitudinal cracks 34 open along the length of the stem, together with the transverse folds in the fibers of the stalk T produced by the triangular teeth 27 after they are driven in, significantly increase the contact surface of the stem with the soil microorganisms once the tillage is produced so as to promote a higher rate of degradation of the stubble in cold climates. On the other hand, by lowering the stalk practically without cutting it and despite said cracks 34 in warm to hot climates where either no-till or minimum tillage is practiced—both practices promoting soil protection through the presence of this stubble on the surface until the next crop is sown—said whole stalk will remain beyond the reach of soil microorganisms causing their decomposition and will offer greater resistance to winds.

Thus, while not conforming to the extremely specific needs of certain extreme agroclimatic conditions, with respect to the treatment of the stubble, it offers the additional and secondary advantage of being adaptable to most of them without compromising its primary objective.

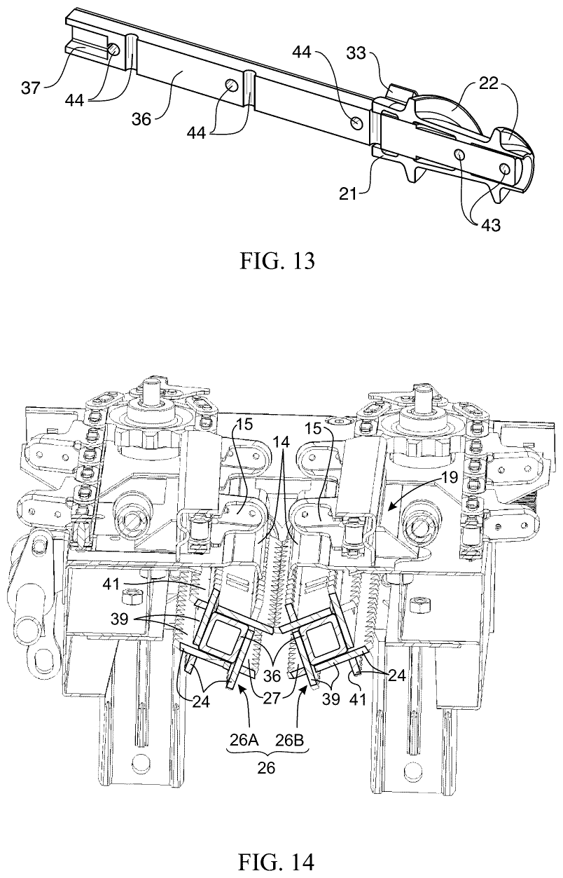

The traction zone 23 of each of the rollers 26 may comprise a squared shaft 36 preferably a square solid bar machined to a round shape at its front end-where tip 21 is attached, spirals 22 are affixed by means of spring pins in holes 43 and machined to square female at its rear 37 where it is connected to a drive gearbox, as is apparent from the FIG. 13. Alternatively, it may comprise a square pipe with a round shaft welded at the front-end.

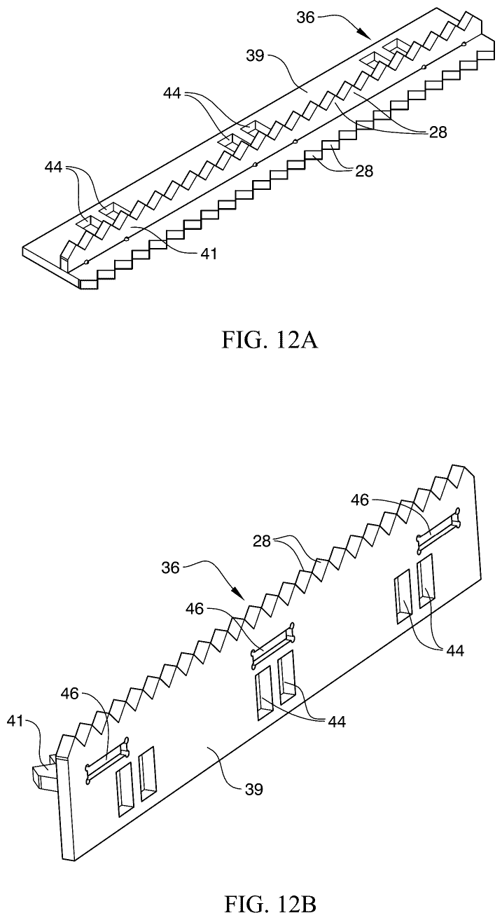

These constructions define four planar longitudinal faces 38 on which respective plates 39 are supported, as shown in FIGS. 12A and 12B. On a flat face of each plate 39 a longitudinal slat 41 is fixed perpendicularly, for example, by welding (and/or by inserts 46 as shown in FIG. 35 of patent AR 109.388). Plates 39 are bolted 42 to perforations 44 on their flat faces and to roller shaft 36, which simplifies the replacement of worn blades. Previously, the outer longitudinal edge of each plate 39 and of each slat 41 is serrated to form triangular toothing 27 in slats 24 defining sharp edges 28 at their external vertices. Each plate 39 and its slat 41 compose a respective pair 31 of blades 24.

The spiral formed by the helical protrusions 22 extends to one or two centimeters of the tip 21 junction to the traction zone 23 and, before reaching that junction, the helical protrusions 22 change in direction abruptly and continue backward for a longitudinally straight short span 33 that collinearly abuts a first protrusion 24A of said pair of protrusions 31 in traction zone 23. The short sections of straight flute 33 in the tip engage in the first lowering movement of the plant T and are important in overcoming the inertia of the still plant.

Since there are fewer helical protrusions 22 in tip 23 than pairs of flutes 31 in the transition zone 23, not all of the first leading blades or blades 24A thereof are preceded longitudinally by helical protrusions. In this embodiment, there are two spiral protrusions 22 and four pairs 31 of blades, such that there are two leading blades 24A preceded only by the short straight fin length 33 at the tip, which does not overlap with any spiral.

FIG. 14 illustrates the assembly of the set of snapping rollers 26 in a row-unit 19 of the corn head below the deck plates 14, on top of which are conventional gathering chains 15. FIG. 15 illustrates a scraper shaped as a plate 47 provided with teeth 28 offset longitudinally half tooth d on both side edges, which lies in-between and below the pair of snapping rollers 26 as schematically indicated in FIGS. 8C and 8D, so that both side edges mesh with the corresponding toothing of the snapping rollers 26.

Particular embodiments of a set of snapping rollers 26 for a corn harvester head have been described above without detriment that changes in materials, shapes, sizes, geometry, construction and arrangement of the components may be practiced without departing from the scope of the present invention defined in the claims that follow. For example, eight blades 26 rollers have been illustrated, with teeth 27 in the form of straight ridge isosceles triangles, however the number and arrangement of blades 24 or curvatures in the teeth 27 may be changed as a variant of the present invention.

1. A snapping assembly for a corn harvester head, which includes a pair of side-by-side mounted snapping rollers each having longitudinal protrusions for grabbing plant stalks and pulling them downward during a corn ear separating movement, wherein said longitudinal protrusions of the pair of snapping rollers are dented or serrated and meshed with each other, and wherein, in operation, tangential rotational speeds of the meshed protrusions are equal.

2. The snapping assembly of claim 1, wherein the rollers of each pair have a longitudinal displacement relative to each other equal to one-half the width of a tooth, such that the teeth of a roller are meshed with those of their counterpart.

3. The snapping assembly of claim 2, wherein the minimum distance between teeth, measured parallel to an axial plane common to the pair of rollers, is from about 1 to 3 mm at its maximum proximity.

4. The snapping assembly of claim 2, wherein the distances between consecutive longitudinal protrusions are unequal.

5. The snapping assembly of claim 4, wherein the longitudinal projections are paired to form pairs of projections on the same roller, the projections on the same roller being separated by a distance less than the distance between different pairs of projections on the same roller.

6. The snapping assembly of the claim 1, having flutes or blades equidistant from each other.

7. The snapping assembly of claim 1, comprising consecutive toothed flutes or blades, wherein the distances between consecutive toothed flutes or blades of each roller are such that the toothed blade that has grabbed the stalk does not lose contact with said stalk before a tooth in next toothed blade grabs and firmly pierces the stalk.

8. The snapping assembly of claim 1, wherein both rollers have the same diameter and thereby identical peripheral or tangential velocity and with opposing flutes or blades of the same size so that the tangential rotational speeds of intermeshing teeth are equal.

9. The snapping assembly of claim 1, wherein said longitudinal protrusions are comprised of flutes with blunt edges to achieve less aggressive treatment on the stubble.

10. The snapping assembly of claim 1, wherein said longitudinal protrusions are composed of blades or knives with beveled and sharp edges to produce an aggressive treatment of the stubble.

11. The snapping assembly of claim 10, wherein the flutes or blades are serrated and pointed.

12. The snapping assembly of claim 11, wherein said serrated flutes or blades possess a succession of triangular teeth.

13. The snapping assembly of claim 5, wherein each snapping roller includes a cylindrical traction zone to which is attached, at the front end of the roller, a generally conical tip through which at least some flutes or blades of the snapping assembly continue in the form of spiral helical projections, smooth without teeth.

14. The snapping assembly of claims 13, wherein the spiral formed by said helical protrusions extends to the proximity of the joint of the tip to the traction zone, but without reaching the joint, where the protrusions change direction and continue longitudinally straight in a backward direction collinearly with a first protrusion of said pair of protrusions of the traction zone.

15. The snapping assembly of claim 13, wherein said traction zone of each roller comprises a squared shaft with flat longitudinal faces and a plurality of plates supported on said flat faces so as to project a serrated longitudinal edge to form the toothed blades.

16. The snapping assembly of claim 15, wherein said roller shaft has a square cross-section, and each roller carries eight blades forming four pairs, two blades of one same pair being perpendicular to each other and consecutive blades of consecutive pairs parallel to each other.

17. The snapping assembly of claim 15, wherein the blades are bolted to said flat longitudinal faces of the roller shaft.

18. A corn harvester head provided with a plurality of row-units each including gathering chains mounted on top of a pair of deck plates between which there is a passageway, wherein each row-unit further comprises a pair of snapping rollers according to claim 1, mounted, respectively, below said pair of deck plates.

19. The harvester head of claim 18, wherein a scraper is placed below and between the pair of snapping rollers of the respective row-units shaped as a plate provided with teeth, offset longitudinally, on both side edges intermeshed with the corresponding toothing of the snapping rollers.

20. A method for cutting the ears from corn plants during harvest after delivering the plant to a pair of rollers of a snapping assembly according to claim 7, wherein it comprises the following steps:
rotating both the snapping rollers with opposite rotational directions to move a pair of first protrusions facing each other with downward tangential velocity, in order to contact and tighten the stalk of the plant and sink their teeth into the said stalk, pulling it downwards to overcome the inertia of the still plant;
continuing to rotate both snapping rollers to cause a pair of second protrusions, facing each other, of the rollers to sink their teeth into said stalk at a greater height than the teeth of the pair of first protrusions before the pair of first blades lose their contact and traction on the stalk, to keep the stalk in downward motion without losing continuity or fluidity in the downward motion such that, if the stalk is cut at the height of the contact with the pair of first blades, the second pair of blades will continue to pull down the stalk portion above the cut; and
continuing to rotate both snapping rollers to cause a pair of third set of intermeshed protrusions in the rollers to sink their teeth into said stalk at a greater height than the teeth of the pair of second protrusions before the pair of second blades lose their contact and traction on the stalk, and so on, to maintain the continuity or fluidity of the downward movement of the stalk without losing traction thereon until snapping the ear from the corn plant.

21. The method of claim 20, wherein the contact of the pair of second blades against the stalk is closer to the contact of the pair of first blades than the contact of the pair of third blades.

22. The method of claim 20, wherein the tangential velocities of both rollers are the same.
